(19) United States
(12) Patent Application Publication
(10) Pub. No.: US 2006/0126725 A1
(43) Pub. Date: Jun. 15, 2006

(54) Automated test vector generation for complicated video system verification

(76) Inventors: Weimin Zeng, San Jose, CA (US); Yaojun Luo, Pleasanton, CA (US); Yu T. Tian, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/123,582

(22) Filed: May 5, 2005

Related U.S. Application Data
(60) Provisional application No. 60/635,114, filed on Dec. 10, 2004.

(51) Int. Cl. H04N 11/04; H04B 1/66; H04N 11/02; H04N 7/12

(52) U.S. Cl. 375/240.03; 375/240.24; 375/240.25; 375/240.2; 375/240.23

(57) ABSTRACT

According to one embodiment, the present invention generates a test vector for verification of a video encoder or decoder by encoding video data using a permissible combination of parameters. One embodiment of the present invention provides for verification of a video decoder by performing at least one video decoding operation and comparing a resulting partially or fully decoded test vector to an expected value. Another embodiment of the present invention provides for verification of a video encoder by performing at least one video encoding operation using a selected combination of parameters, and comparing a resulting partially or fully encoded test vector to an expected value.

### CROSS-REFERENCE TO RELATED APPLICATION

This application claims the benefit of U.S. Provisional Patent Application No. 60/635,114 filed on Dec. 10, 2004, which is incorporated by reference herein in its entirety.

### BACKGROUND OF THE INVENTION

1. Field of the Invention

The present invention relates generally to video compression and decompression, and more particularly to verification of a video encoder and decoder.

2. Background Art

Digital video is made up of many megabytes of pixel data per second of video. Storage, transmission, and processing of video data can be costly, consuming valuable resources such as memory, bandwidth, processing power, and time. Video data processing taxes even the fastest computer systems due to large image sizes and fast frame rates.

With the advent of digital television and streaming media, a number of new techniques have been developed over the recent past to allow video data to be processed and compressed. Moreover, a number of standards have been developed such as those developed by the Moving Pictures Experts Group (MPEG) for coding audio-visual information in a digital compressed format. Various new standards such as MPEG-4 or Advanced Video Coding (AVC) H.264 have been recently developed or are being developed and provide various parameters to define the processing of digital video data. Additionally, there are a number of different transformation types that are being used to process and compress video data.

A video encoder processes and compresses video data by performing techniques such as motion estimation and compensation, discrete cosine transform (DCT), quantization, and variable length coding (VLC). A video decoder performs decompression of video data by performing techniques such as variable length decoding, inverse quantization, inverse DCT, and inverse motion estimation and compensation.

A video encoder or decoder supports one or more applications or features provided by a standard. For example, a fully compatible video encoder or decoder requires full coverage of all the features defined in a standard. Other encoders or decoders support a particular profile, which is a set of tools that can be used for supporting specific features.

For verification of a decoder, a standard typically requires a compatible decoder to pass a set of conformance bitstreams, which are test bitstreams designed to verify a decoder. However, conformance bitstreams are not enough for proper verification of a video decoder because they do not cover various features and various possible combinations of encoding parameters.

Additional bitstreams for verification of a video decoder are conventionally provided by using a reference encoder provided by a standards committee for encoding some additional bitstreams. However, a reference encoder is time-consuming because it performs motion estimation and compensation. Another problem with a reference encoder is that it does not allow all features to be verified, nor does it allow all parameters to be controlled. Therefore, a reference encoder does not provide for proper verification of a video decoder.

Further, conventional verification techniques do not allow for proper verification of a video encoder's features using various possible combinations of encoding parameters.

Accordingly, there is a need for techniques that allow proper verification of various features of a video encoder and/or decoder.

### SUMMARY OF THE INVENTION

One embodiment of the present invention provides techniques for verification of a video encoder and decoder. According to one embodiment, the present invention automatically generates a test vector for verification of a video encoder or decoder by receiving video data for generating the test vector, selecting a combination of parameters for encoding the video data, determining whether a selected combination of parameters is permissible, and encoding the video data using the selected parameters if the combination is permissible. Parameters may be defined by one or more standards, for example, MPEG1, MPEG2, MPEG4, H.263, H.264 and MSVC.

According to one embodiment, the present invention performs verification of a video decoder by receiving a test vector generated using a selected combination of parameters, performing video decoding to generate a partially or fully decoded test vector, and comparing the partially or fully decoded test vector to an expected value stored in memory. For example, performing video decoding includes one or more video decoding operations such as variable length decoding, inverse quantization, inverse discrete cosine transform, and inverse motion prediction.

According to another embodiment, the present invention performs verification of a video encoder by performing video encoding to generate a partially or fully encoded test vector using selected parameters and comparing the partially or fully encoded test vector to an expected value stored in memory. For example, performing video encoding includes one or more video encoding operations such as motion estimation and compensation, DCT, quantization, and variable length coding.

According to one embodiment of the present invention, parameters from one or more levels are selected randomly. According to another embodiment, the present invention selects one or more parameters specified by a user. According to a further embodiment, the present invention selects a combination of parameters to test a corner case. According to a still further embodiment, the present invention selects parameters by cycling through various parameter combinations.

According to one embodiment, the selected parameters comprise stream level parameters, picture level parameters, slice level parameters, macroblock level parameters, block level parameters, and sub-block level parameters. By automatically generating various possible parameters of a stream, picture, slice, macroblock, block or sub-block, one embodiment of the present invention enables proper verification and debugging of a video encoder or decoder, including verification of corner cases.

### BRIEF DESCRIPTION OF THE DRAWINGS

FIG. 1 is a block diagram of a system for verification of a video encoder and/or decoder according to one embodiment of the present invention.

FIG. 2 is a block diagram of a system for verification of a video encoder and/or decoder, showing further details of a standard library and a vector generator, according to one embodiment of the present invention.

FIG. 3 is a block diagram of a system for verification of a video encoder or decoder, showing further details of a video decoder, according to one embodiment of the present invention.

FIG. 4 is a flowchart of a method of generating a test vector according to one embodiment of the present invention.

### DETAILED DESCRIPTION OF THE INVENTION

Various embodiments of the present invention provide techniques that allow proper verification of various features of a video encoder and/or decoder. Various embodiments of the present invention provide for efficiently generating test vectors using various combinations of encoding parameters so as to allow proper verification of a video encoder and/or decoder.

Various embodiments of the present invention are now described more fully with reference to the accompanying figures. The present invention may be embodied in many different forms and should not be construed as limited to the embodiments set forth herein. Rather these embodiments are provided so that this disclosure will be complete and will fully convey the invention to those skilled in the art.

In the following description, for purposes of explanation, numerous specific details are set forth in order to provide a thorough understanding of the invention. It will be apparent, however, to one skilled in the art that the invention can be practiced without these specific details. In some instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the method steps. The structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

A test vector is a bitstream of video data encoded using selected parameters. Verification of a video encoder or decoder involves testing one or more operations of the video encoder or decoder using one or more test vectors. One embodiment of the present invention verifies one or more operations of a video encoder, such as motion estimation and compensation, discrete cosine transform, quantization, and variable length coding. Another embodiment of the present invention verifies one or more operations of a video decoder such as variable length decoding, inverse quantization, inverse DCT, and inverse motion estimation and compensation.

One embodiment of the present invention generates test vectors using various combinations of parameters at one or more levels, such as stream level parameters, picture level parameters, slice level parameters, macroblock level parameters, block level parameters, and sub-block level parameters. Another embodiment of the present invention is capable of automatically generating various possible parameters in one or more standards, thereby allowing verification of all features of a video encoder or decoder, including corner cases. A further embodiment of the present invention determines whether a particular combination of parameters is permissible before generating a test vector using that combination.

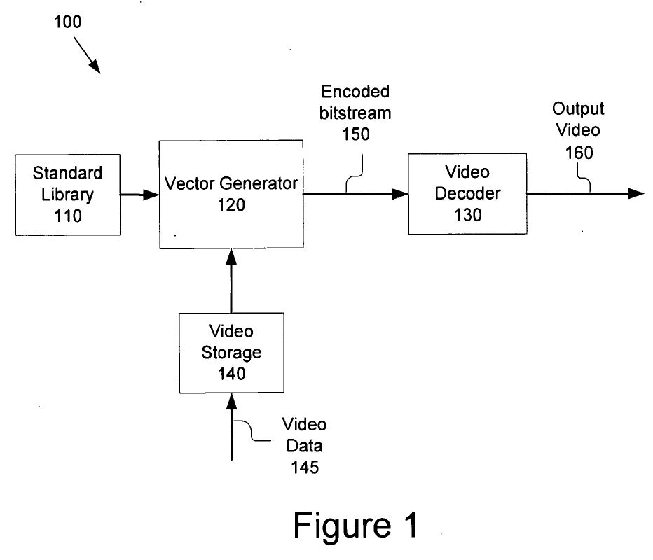

FIG. 1 shows a block diagram of a verification system 100 for verification of a video encoder or decoder according to one embodiment of the present invention. According to one embodiment, the system in FIG. 1 represents hardware for verification of a video encoder or decoder. A hardware embodiment of the invention has been described for ease of understanding. However, one skilled in the art will recognize that the modules, features, attributes, methodologies, and other aspects of the invention can be implemented as software, hardware, firmware or any combination of the three.

The verification system 100 comprises a standard library 110, a vector generator 120, a video decoder 130, and video storage 140.

The standard library 110 has an input (not shown) and one or more outputs and is used to store parameters available for one or more standards such as MPEG 1, 2, and 4, H.263, H.264, and MSVC1. According to one embodiment, the input of standard library 110 is coupled to receive possible parameters for each standard as well as a valid range of parameter values for the standard. The outputs of standard library 110 are coupled to of vector generator 120 to provide parameters for encoding video data.

Video storage 140 has an input and an output and is used to store video data for generating test vectors. According to one embodiment, video storage 140 stores uncompressed or partially compressed video files. The input of video storage 140 is coupled to receive video data 145, while the output of video storage 140 is coupled to vector generator 120 to provide video data used in generating test vectors.

Vector generator 120 has two inputs and an output and is used to generate test vectors for verification of a video encoder 250 or video decoder 130. One input of vector generator 120 is coupled to receive parameters from standard library 110 while another input of vector generator 120 is coupled to receive video data from video storage 140. According to one embodiment, vector generator 120 encodes video data using parameters from standard library 110 to generate a test vector. The output of vector generator 120 is coupled to video decoder 130 to provide an encoded bitstream 150 comprising a test vector. According to one embodiment, vector generator 120 is implemented in software. According to a further embodiment of the present invention, vector generator 120 efficiently generates test vectors without performing motion estimation and compensation.

Video decoder 130 has an input and an output and decodes test vectors in encoded bitstream 150 to generate output video 160. For example, output video 160 comprises uncompressed video. According to one embodiment, video decoder 130 is implemented as an ASIC. According to another embodiment, video decoder 130 is a simulator that models a decoder in software. The input of video decoder 130 is coupled to receive an encoded bitstream 150 from vector generator 120. According to one embodiment of the present invention, the output of video decoder 130 provides output video 160 to a comparator (not shown) that determines whether output video 160 corresponds to expected values.

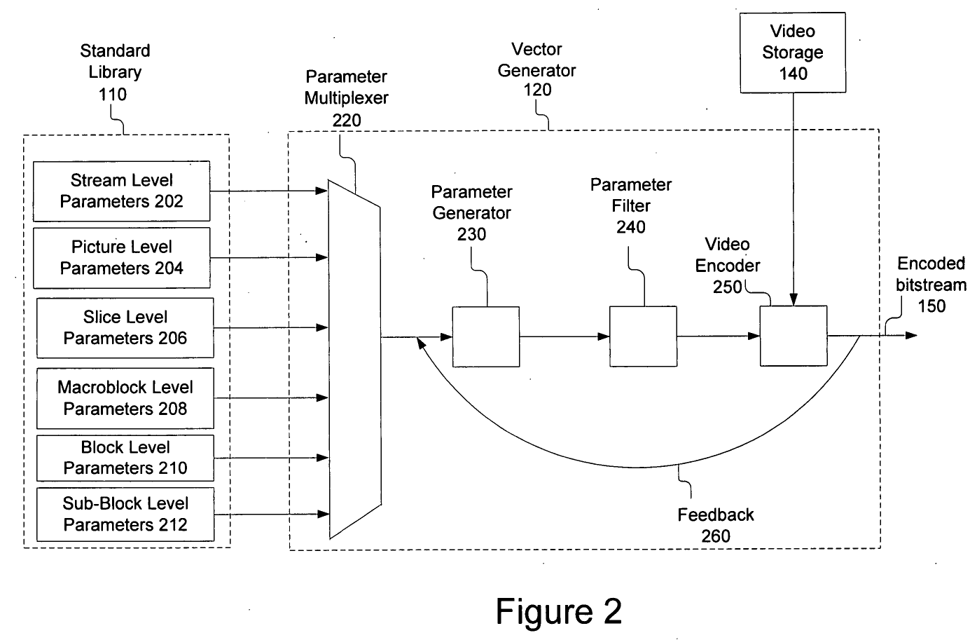

FIG. 2 is a block diagram of a system for verification of a video encoder and/or decoder, showing further details of a standard library and a vector generator, according to one embodiment of the present invention.

As shown in FIG. 2, standard library 110 stores parameters available for one or more levels. For example, standard library 110 stores stream level parameters 202, picture level parameters 204, slice level parameters 206, macroblock level parameters 208, block level parameters 210 and sub-block level parameters 212. According to one embodiment of the present invention shown in FIG. 2, parameters from each level in standard library 110 are available to vector generator 120 via an output for each level of parameters. Exemplary parameters available at various levels for multiple standards are shown in Appendix A1. Appendix A2 provides an exemplary list of parameters for various exemplary standards.

As shown in FIG. 2, vector generator 120 comprises a parameter multiplexer 220, a parameter generator 230, a parameter filter 240, and a video encoder 250. Parameter multiplexer 220 has one or more inputs and an output and is used to provide parameters from one or more levels to parameter generator 230. One or more inputs of parameter multiplexer 220 receive parameters at various levels from standard library 110, while the output of parameter multiplexer 220 provides parameters to parameter generator 230.

Parameter generator 230 has an input and an output and is used to select a combination of parameters from one or more levels for generating a test vector. The input of parameter generator 230 is coupled to parameter multiplexer 220 for receiving parameters from one or more levels. The output of parameter generator 230 provides a selected combination of parameters to parameter filter 240. According to one embodiment of the present invention, parameter generator 230 randomly selects a combination of parameters for verification of a video encoder or decoder. According to another embodiment, parameter generator 230 selects a combination of parameters specified by a user. For example, a user may specify one or more parameters by selecting one or more features of a video encoder or decoder for verification. According to a further embodiment, parameter generator 230 cycles through various possible parameter combinations, thereby allowing proper verification of video encoder 250 or video decoder 130. According to yet another embodiment, parameter generator 230 selects a combination of parameters to test a corner case, thereby facilitating verification and debugging of video encoder 250 or video decoder 130. According to one embodiment of the present invention, Appendix C provides an exemplary parameter combination used to test a corner case. According to one embodiment of the present invention, the parameter combination in Appendix C is used to test DRAM bandwidth. For example, in Appendix C, CodingOption is set to 3 for interlaced video, MotionDirection is set to 2 so that all macroblocks have bidirection prediction and SubMotionSplitMode is set to 3 so that partitions for macroblocks are 4×4.

Parameter filter 240 has an input and an output and is used to determine whether a selected combination of parameters is permissible and to discard impossible or impermissible combinations. The input of parameter filter 240 is coupled to parameter generator 230 to receive a selected combination of parameters. The output of parameter filter 240 is coupled to video encoder 250 to provide a permissible combination of parameters to video encoder 250. According to one embodiment, parameter filter 240 determines whether parameters in a combination are consistent.

To provide an example of a consistent combination of parameters, while generating an interlaced test case in H.264 mode, the smallest partition of a direct mode macroblock should be 8×8. Therefore, according to one embodiment of the present invention, the following exemplary combination of parameters is consistent: CompressMode=5 (0: MPEG1, 1: MPEG2, 3: h263, 4: MPEG4 ASP, 5: H.264, 6: VC-1); CodingOption=3 (interlaced video); and Direct_{—}8×8_inference flag=1 (H264 only: at direct mode, 1: 8×8 partition; 0: 4×4 partition). Further, according to one embodiment of the present invention, the following exemplary combination of parameters is inconsistent: CompressMode=5 (0: MPEG1, 1: MPEG2, 3: h263, 4: MPEG4 ASP, 5: H.264, 6: VC-1); Codingoption=3 (interlaced video); and Direct_{—}8×8_inference_flag=0 (H264 only: at direct mode, 1: 8×8 partition; 0: 4×4 partition).

According to one embodiment of the present invention, if Direct_{—}8×8_inference_flag is set to 0, parameter filter 240 corrects Direct_{—}8×8_inference_flag to 1 and sends feedback 260 to parameter generator 230. According to one embodiment of the present invention as shown in FIG. 2, feedback 260 is sent to parameter generator 230 via video encoder 250. According to another embodiment of the present invention, parameter filter 240 sends feedback directly to parameter generator 250.

For example, parameters may be ranked according to the following hierarchy: stream level parameters 202, picture level parameters 204, slice level parameters 206, macroblock level parameters 208, block level parameters 210, and sub-block level parameters 210, where lower-level parameters should be consistent with higher-level parameters. According to another embodiment, parameter filter 240 determines whether a combination of parameters is permissible under a particular standard. According to a further embodiment, parameter filter 240 determines whether a parameter in the combination is permissible under a standard.

Appendix D provides an exemplary parameter combination that is permissible under MPEG4, according to one embodiment of the present invention. Further, adaptive frame/field coding is not allowed under MPEG4. Therefore, according to one embodiment of the present invention, an exemplary impermissible combination of parameters is given by: CompressMode=4 (0: MPEG1, 1: MPEG2, 3: h263, 4: MPEG4 ASP, 5: H.264, 6: VC-1) and CodingOption=1 (Frame-level control: 0: frame coding, 1: adaptive frame/field coding, 2: field coding, 3: MB adaptive frame/field coding).

Video encoder 250 has two inputs and an output and is used to generate a test vector by encoding video data from video storage 140 using a permissible combination of parameters received from parameter filter 240. One input of video encoder 250 is coupled to video storage 140 to receive an uncompressed or partially compressed video file. Another input of video encoder 250 is coupled to parameter filter 240 to receive a permissible combination of parameters. The output of video encoder 250 is coupled to video decoder 130 to provide a partially or fully encoded bitstream comprising test vectors for verification of video decoder 130. According to one embodiment, video encoder 250 is capable of encoding video data for one or more standards, such as MPEG 1, 2, or 4, H.263, H.264, or MSVC. According to another embodiment, video encoder 250 is also capable of encoding other types of data such as audio data.

One embodiment of the present invention allows verification of one or more operations performed by video encoder 250, such as motion estimation and compensation, DCT, quantization and VLC. For example, once video encoder 250 performs motion estimation and compensation using a selected combination of parameters, a comparator (not shown) compares the partially encoded bitstream resulting from motion estimation and compensation to expected values. According to one embodiment, expected values for partially or fully encoded bitstreams generated using a particular parameter combination are stored in a memory (not shown) accessible to the comparator. Therefore, one embodiment of the present invention advantageously allows verification of a video encoder 250 implemented as an ASIC.

According to one embodiment of the present invention, an encoded bitstream 150 comprising test vectors is input to parameter generator 230 via feedback 260. According to one embodiment, by using feedback 260 and changing one or more selected parameters, vector generator 120 is able to efficiently generate additional test vectors and thereby improve coverage of verification system 100. According to another embodiment, feedback 260 enables changing one or more selected parameters in real time. According to a further embodiment, feedback 260 is also useful for generation of B frames and P frames, which are encoded in reference to frames preceding or following them. According to a still further embodiment, feedback 260 provides an indication that an inconsistent combination of parameters was previously generated by parameter generator 230.

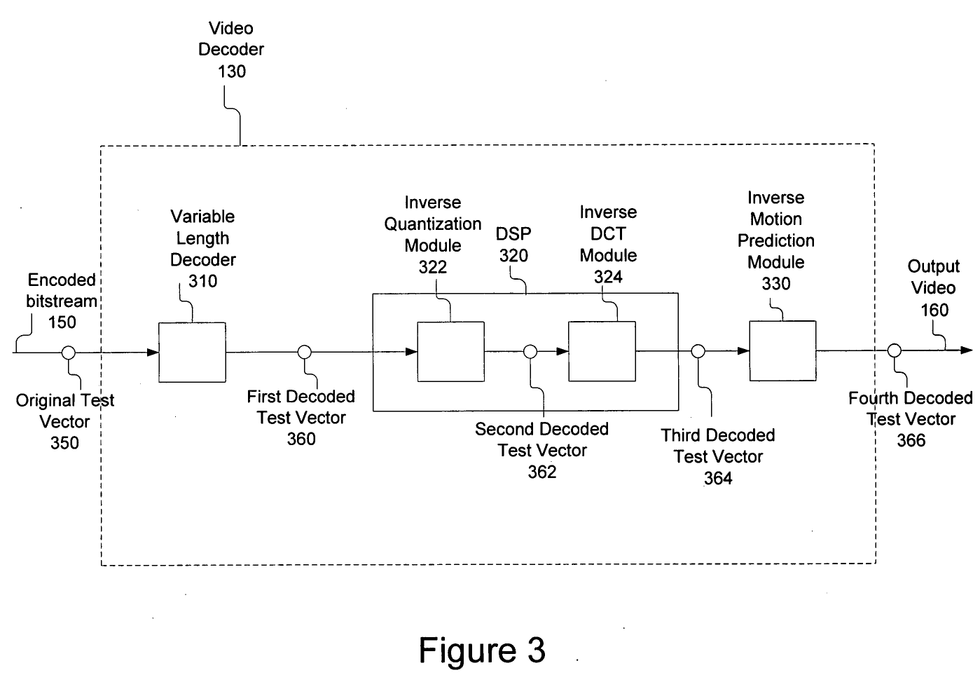

FIG. 3 is a block diagram of a system for verification of a video encoder or decoder, showing further details of video decoder 130, according to one embodiment of the present invention. According to one embodiment, video decoder 130 comprises a variable length decoder 310, a digital signal processing module (DSP) 320, and an inverse motion prediction module 330. Verification system 100 advantageously enables verification of one or more operations of video decoder 130, such as variable length decoding, inverse quantization, inverse DCT, and inverse motion estimation and compensation.

Variable length decoder 310 has an input and an output and performs variable length decoding of test vectors in encoded bitstream 150 to generate partially decoded test vectors. The input of variable length decoder 310 is coupled to receive encoded bitstream 150, while the output of variable length decoder 310 is coupled to DSP 320 to provide partially decoded video data. For example, variable length decoder 310 performs variable length decoding of an original test vector 350 to generate a first decoded test vector 360 that represents partially decoded video data.

According to one embodiment, expected values for partially or fully decoded video data are stored in a memory (not shown) accessible to a comparator (not shown). For example, the memory stores expected values for first decoded test vector 360 resulting from variable length decoding of an original test vector 350 that was generated by encoding a video file using a particular combination of parameters. According to a further embodiment, the comparator verifies the operation of variable length decoder 310 by comparing the first decoded test vector 360 to the expected values stored in the memory.

According to one embodiment shown in FIG. 3, DSP 320 comprises an inverse quantization module 322 and an inverse DCT module 324. Inverse quantization module 322 has an input and an output and performs inverse quantization of first decoded test vector 360 to generate a second decoded test vector 362. The input of inverse quantization module 322 is coupled to variable length decoder 310 to receive first decoded test vector 360, while the output of inverse quantization module 322 is coupled to inverse DCT module 324 to provide second decoded test vector 362 that has undergone inverse quantization. According to one embodiment, expected values of second decoded test vector 362 resulting from inverse quantization of first decoded test vector 360 are stored in memory. According to a further embodiment, a comparator verifies the operation of inverse quantization module 322 by comparing second decoded test vector 362 to expected values stored in memory.

Inverse DCT module 324 has an input and an output and performs an inverse discrete cosine transform on second decoded test vector 362 to generate a third decoded test vector 364. The input of inverse DCT module 324 is coupled to inverse quantization module 322 to receive second decoded test vector 362, while the output of inverse DCT module 324 is coupled to inverse motion prediction module 330 to provide a third decoded test vector 364 that has undergone an inverse discrete cosine transform. According to one embodiment, expected values of third decoded test vector 364 resulting from inverse DCT of second decoded test vector 362 are stored in memory. According to a further embodiment, a comparator verifies the operation of inverse DCT module 324 by comparing third decoded test vector 364 to expected values stored in memory.

Inverse motion prediction module 330 has an input and an output and performs inverse motion estimation and compensation of third decoded test vector 364 to generate output video 160 comprising fourth decoded test vector 366. The input of inverse motion prediction module 330 is coupled to receive third decoded test vector 364 from inverse DCT module 324, while the output of inverse motion prediction module 330 is coupled to provide fourth decoded test vector 366 to, for example, a video display device or a storage device. According to one embodiment, expected values of fourth decoded test vector 366 resulting from inverse motion estimation and compensation of third decoded test vector 364 are stored in memory. According to a further embodiment, a comparator verifies the operation of inverse motion prediction module 330 by comparing fourth decoded test vector 366 to expected values stored in memory.

According to one embodiment of the present invention, verification system 100 is capable of verifying one or more operations of a video encoder or decoder in a single step. For example, to verify the combined operations of variable length decoding and inverse quantization in a single step, a comparator determines whether second decoded test vector 362 corresponds to expected values stored in memory.

In the above paragraphs, video encoding and decoding operations such as motion estimation and compensation and inverse quantization are discussed as examples to illustrate techniques for verification of a video encoder or decoder according to one embodiment of the present invention. Note that a further embodiment of the present invention is capable of verifying other operations of a video encoder or decoder as well as various combinations of video encoding and decoding operations.

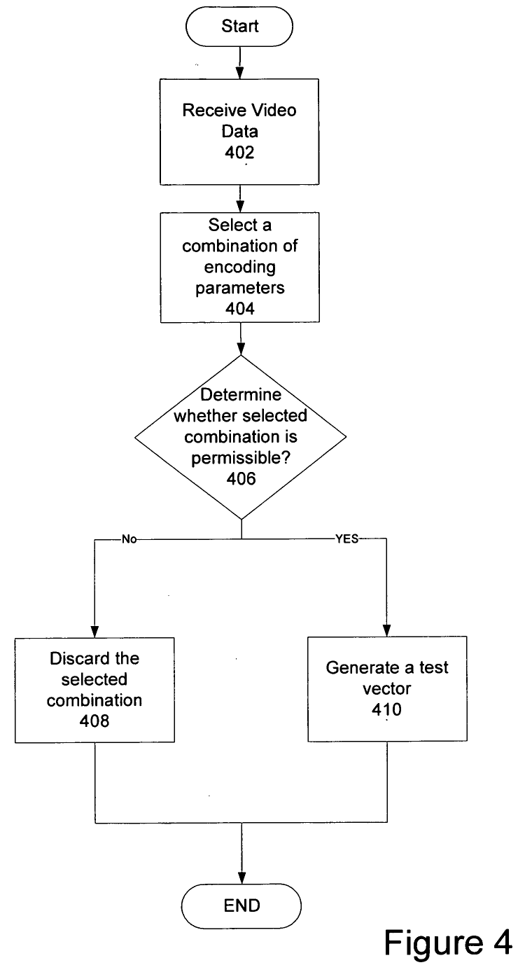

FIG. 4 is a flowchart of a method of generating a test vector according to one embodiment of the present invention. The method begins by receiving video data 402, for example an uncompressed or partially compressed video file, for generating a test vector.

At step 404, the method continues by selecting a combination of encoding parameters for generating a test vector. According to one embodiment of the present invention, the method selects parameters from one or more levels, such as stream level parameters, picture level parameters, slice level parameters, macroblock level parameters, block level parameters and sub-block level parameters. According to a further embodiment shown in FIG. 2, these parameters are stored in standard library 110 and are selected by parameter generator 230 via a parameter multiplexer 220. According to one embodiment of the present invention, parameters from one or more levels are selected randomly. According to another embodiment, the method selects one or more parameters specified by a user. According to a further embodiment, the method selects a combination of parameters to test a corner case. According to a still further embodiment, the method selects parameters by cycling through various parameter combinations.

According to one embodiment of the present invention, an algorithm of a method for selecting parameters to encode a stream of video data is shown in Appendix B. The algorithm in Appendix B first defines valid stream level parameters for a particular standard and generates stream level parameters for compression. Next, for each picture in the stream, the algorithm defines valid picture level parameters for the standard and generates picture level parameters for compression. Next, for one or more macroblocks in a picture the algorithm defines valid macroblock parameters and generates macroblock level parameters for compression. According to one embodiment of the present invention, if a selected parameter combination is permissible, the algorithm encodes video data using the selected parameter combination to generate a test vector for verification of a video encoder or decoder.

At step 406, the method determines whether a selected combination of parameters is permissible. According to one embodiment, at step 406 the method determines whether parameters in a combination are consistent with each other. According to another embodiment, at step 406 the method determines whether a combination of parameters is permissible under a particular standard. According to a further embodiment, at step 406 the method determines whether one or more parameters in the combination are permissible under a standard.

If a selected combination of parameters is impermissible, then at step 408 the method discards the selected combination. If a selected combination of parameters is permissible, the method generates a test vector 410 by encoding video data using the selected combination. One embodiment of the present invention allows verification of one or more operations performed by a video encoder at step 410, such as motion estimation and compensation, DCT, quantization and VLC. According to this embodiment, a comparator verifies a video encoder by comparing partially or fully encoded test vectors generated by the encoder to expected values stored in a memory. According to another embodiment of the present invention, a test vector generated at step 410 is used to verify one or more operations of a video decoder, such as variable length decoding, inverse quantization, inverse DCT, and inverse motion estimation and compensation.

According to one embodiment of the present invention, the method changes one or more parameters of the selected combination to generate a second combination of parameters for encoding the video data. According to another embodiment, the method determines whether the second combination of parameters is permissible, and generates a second test vector by encoding the video data using the second combination if the second combination is permissible. According to a further embodiment, generating a second test vector by changing one or more selected parameters can be achieved in real time and is also useful for generation of B frames and P frames.

This description is included to illustrate the operation of exemplary embodiments and is not meant to limit the scope of the invention. From this discussion, many variations will be apparent to one skilled in the relevant art that are encompassed by the spirit and scope of the invention.

### APPENDIX A2

### An Exemplary List of Parameters for Various Exemplary Standards According to One Embodiment of the Present Invention

I. A. Stream Level Parameters

| Common | MPEG1 | MPEG2 | H.263 |
|---|---|---|---|
| RandomSeed | IdctMethod | IdctMethod | IdctMethod |
| SourceWidth | LoadLumaIntraQ | CodingOption | |
| SourceHeight | LoadLumaInterQ | IntraDCPrecision | |
| FramesToBeEncoded | LumaIntraQTableFile | IntraVLCFormat | |
| IDRPeriod | LumaInterQTableFile | QuantType | |
| GOPSize | | LoadLumaIntraQ | |
| NumOfBFrames | | LoadLumaInterQ | |
| GOPStruct | | LumaIntraQTableFile | |
| ExplicitSubGOPFormat | | LumaIntraQTableFile | |
| ExplicitGOPFormat | | | |
| StressTest | | | |
| QMode | | | |
| MBQuantsFile | | | |
| Skeleton | | | |

I. B. Stream Level Parameters (Continued)

| MPEG4 | H.264 | MSVC-1 |
|---|---|---|
| QuarterPel | ChromaFormat | Profile_level |
| IdctMethod | Profile_level | CodingOption |
| CodingOption | CodingOption | QuantType |
| OBMC_Enable | QuantType | ILF |
| DivXCompatible | PicOrderCntType | Overlap |
| QuantType | POCAssignMode | ExplicitQuantizer |
| LoadLumaIntraQ | MaxPOCLSB | TransformSwitchOn |
| LoadLumaInterQ | Direct_8x8_inference_flag | UVHpelBilinear |
| LumaIntraQTable- | NumOfReferenceFrames | SyncMarker |
| File | FrameNumGaps | stressMVTable |
| LumaInterQTable- | MBAffFlag | MultiResolution |
| File | MaxFrameNum | BIPicture |
| | LongTermRefPic | FptypeRandom |
| | MultiRefBackwardAllowed | SkipFrame |
| | ReorderRefLists | |
| | RedundantPicAllowed | |
| | QmatrixFile | |
| | InLoopfilter | |
| | LoopFilterPresentFlag | |
| | LoopFilterAlphaC0Offset | |
| | LoopFilterBetaOffset | |

II. Picture Level Parameters

| Common | MPEG1 | MPEG2 | H.263 |
|---|---|---|---|
| QuantizerForIFrames | | TopFieldFirst | |
| QuantizerForPFrames | | Alternate_vertical_scan | |
| QuantizerForBFrames | | FramePredFrameDCT | |

| MPEG4 | H.264 | MSVC-1 |
|---|---|---|
| TopFieldFirst | TopFieldFirst | TopFieldFirst |
| Alternate_vertical_scan | Transform8x8ModeFlag | DQUANT |
| Intra_dc_vlc_thr | ScalingListPresentFlag0 | AltQuantizerForIFrames |
| | ScalingListPresentFlag1 | AltQuantizerForPFrames |
| | ScalingListPresentFlag2 | AltQuantizerForBFrames |
| | ScalingListPresentFlag3 | RangeRed |
| | ScalingListPresentFlag4 | RangeMapY |
| | ScalingListPresentFlag5 | RangeMapUV |
| | ScalingListPresentFlag6 | DQProfile |
| | ScalingListPresentFlag7 | Edge |
| | MBTrans8x8 | HalfStep |
| | | XformSwitching |
| | | IntensityCompensation |
| | | IntensityCompensationBot |
| | | IntensityScale |
| | | IntensityScaleBot |
| | | IntensityShift |
| | | IntensityShiftBot |
| | | ACIntraTableIndex |
| | | ACInterTableIndex |
| | | DCIntraTableIndex |
| | | CBPYTableIndex |
| | | 2MVBPTableIndex |
| | | 4MVBPTableIndex |
| | | TwoRefPictures |
| | | UseMostRecentFieldForRef |
| | | BitPlaneCodingMode |
| | | RangeRedFrm |
| | | PicResolution |

III. Slice Level Parameters

| Common | MPEG1 | MPEG2 | H.263 |
|---|---|---|---|
| AllowMissingMB | AllowSkipLastMBinSlice | AllowSkipLastMBinSlice | AllowSkipLastMBinSlice |
| SliceMode | | | |
| SliceArgument | | | |

| MPEG4 | H.264 | MSVC-1 |
|---|---|---|
| AllowSkipFirstMBinSlice | EntropyMode | |
| AllowSkipLastMBinSlice | ChromaQPOffset | |
| | Constrained_intra_pred_flag | |
| | WeightedPrediction | |
| | WeightedBiprediction | |
| | DirectModeType | |
| | SecondChromaQPOffset | |

IV. Macroblock Level Parameters

| Common | MPEG1 | MPEG2 | H.263 |
|---|---|---|---|
| Motion_type | ConcealmentMV | DualPrime_Mode | |
| DCT_type | | DualPrime_frequency | |
| MB_type | | ConcealmentMV | |
| Intra_mode_frequency | | | |
| SplitMode | | | |
| Skip_Mode | | | |
| Skip_mode_frequency | | | |
| MVMode | | | |
| MV.x | | | |
| MV.y | | | |
| Motion_vector_mean_range | | | |
| Motion_vector_variance_range | | | |
| Motion_vector_range | | | |

| MPEG4 | H.264 | MSVC-1 |
|---|---|---|
| Direct_Mode | Direct_Mode | Direct_Mode |
| Direct_mode_frequency | Direct_mode_frequency | Direct_mode_frequency |
| ACPred_frequency | ChromaPredMode | ACPred |
| StuffingMBMode | LumaPredModeMB | ExtendedMV |
| ACPred | LumaPredType | ExtendedDMV |
| | Raw_mode_frequency | StressCoeff |
| | Raw_Mode | PMVMode |
| | | BMVMode |
| | | MVRangeIndex |
| | | DMVRangeIndex |
| | | MBModeTableIndex |
| | | MVTableIndex |

V. Block Level Parameters

| | | | |
|---|---|---|---|
| Common | MPEG1 | MPEG2 | H.263 |

| MPEG4 | H.264 | MSVC-1 |
|---|---|---|
| | SubMotionSplitMode | EscapeSizeRandom |
| | LumaPredModeSubblk | XformType |

VI. Sub-Block Level Parameters

| | | | |
|---|---|---|---|
| Common | MPEG1 | MPEG2 | H.263 |

| MPEG4 | H.264 | MSVC-1 |
|---|---|---|
| | GenerateCBP4x4 | |

APPENDIX B
An algorithm of a method for selecting parameters to encode a stream of
video data, according to one embodiment of the present invention.

```
define and generate stream parameters
for each picture in the stream
{
    define and generate picture parameters
    for each macroblock in the current picture
    {
        define and generate macroblock properties
        if selected parameter combination is permissible
        {
            encode the generated macroblock data into the stream
        }
    }
}
```

APPENDIX C
AN EXEMPLARY PARAMETER COMBINATION USED TO TEST A CORNER
CASE ACCORDING TO ONE EMBODIMENT OF THE PRESENT INVENTION

| | | |
|---|---|---|
| //// Most Used Fields | | |
| // | | |
| RandomSeed | = 3344; | /* random number seed */ |
| SourceWidth | = 176; | /* Source width */ |
| SourceHeight | = 144; | /* Source height */ |
| FramesToBeEncoded | = 30; | /* total frames to be encoded */ |
| //// Sequence Parameters | | |
| // | | |
| CompressMode | = 5; | /* 0: MPEG1, 1: MPEG2, 3: h263, 4: MPEG4 ASP, |
| | | 5: H.264, 6: Corona, 7: WM9 */ |
| IDRPeriod | = 2; | /* Instant Decoder Refrest period in GOPs */ |
| GOPSize | = 15; | /* total frames in one GOP, 0 means only first |
| frame | | is I frame */ |
| NumOfBFrames | = 2; | /* Number of B frames inserted between two P/I |
| frames */ | | |
| SliceMode | = 2; | /* 0: No slice; 1: fix slice pattern; 2: random slice |
| | | pattern */ |
| SliceArgument | = 0; | /* Only valid when SliceMode = 1 (number of |
| | | MBs) WMV9, number of MBs must be |
| | | multiple of number of MBs in a MB row |
| | | (according to one embodiment) */ |
| //// Interlace | | |
| // | | |
| CodingOption | = 3; | /* Frame-level control: 0: frame coding, 1: adaptive |
| | | frame/field coding, 2: field coding, 3: MB |
| | | adaptive frame/field coding. |
| | | MPEG4: only 0 and 3 can be enabled |
| | | MPEG1/H263: only 0 can be enabled (no |
| | | interlace coding) |
| | | MPEG2/WM9/H264: all four options can |
| | | be enabled */ |
| TopFieldFirst | = 0; | /* 0: bottom field first, 1: top field first */ |
| QMode | = 1; | /* 0: always constant; 1: random; 2: pattern file */ |
| //// Prediction Parameters | | |
| MVMode | = 2; | /* 0: constant (0,1/4,1/2,3/4-pel), set by MV.x & |
| | | MV.y; 1: random (determined by mean and |
| | | variance range, generated value can't exceed |
| | | Motion_vector_range according to one |
| | | embodiment); |
| | | 2: comprehensive coverage: H-pel: 4 |
| | | cases; Q-pel: 16 cases */ |
| Motion_vector_mean_range | = 16; | /* motion vector mean range in whole-pel unit, only |
| | | used when MVMode==1 according to one |
| | | embodiment */ |
| Motion_vector_variance_range | = 16; | /* motion vector variance range in whole-pel |
| | | unit, only used when MVMode = 1 according |
| | | to one embodiment */ |
| Motion_vector_range | = 16; | /* motion vector search range: |
| | | 16/32/64/128/256/512/1024, in whole-pel unit, |
| | | only used when MVMode==1 according |
| | | to one embodiment */ |
| //// Macroblock Properties | | |
| // | | |
| Motion_type | = 2; | /* 0: all frame, 1: all field, 2: mix of frame & field |
| | | (equal probability), 3: mix of frame & field |
| | | (pattern file) |
| | | field prediction can be enabled when |
| | | CodingOption is set to 1, 2, or 3. |
| | | frame prediction can be enabled when |
| | | CodingOption is set to 0, 1, or 3. */ |
| MB_type | = 2; | /* 0: all intra, 1: all inter, 2: inter/intra mix */ |
| Intra_mode_frequency | = 16; | /* intra mode generated at one of |
| | | Intra_mode_frequency used only in inter/intra |
| | | mix case, according to one embodiment*/ |
| SplitMode = 1; | | /* 0: 16x16; 1: 8x8; 2: 16x8; 3: 8x16; 4: random |
| | | mix (equal probability). |
| | | Note for MPEG4, only 16x16 and 8x8 split can |
| | | be choosen, and for field-prediction |
| | | choosing 16x16 will be treated as 16x8 split. */ |
| Skip_Mode | = 1; | /* 0: no skip mode; 1: random; 2: pattern */ |
| Direct_Mode | = 1; | /* 0: no direct mode; 1: random; 2: pattern */ |
| Skip_mode_frequency | = 16; | /* skip mode generated at one of |
| | | Skip_mode_frequency (>1) used only in random |
| | | mode, according to one embodiment. */ |
| Direct_mode_frequency | = 16; | /* direct mode generated at one of |
| | | Direct_mode_frequency used only in random |
| | | mode, according to one embodiment. */ |
| MotionDirection | = 2; | /* 0: all forward, 1: all backward, 2: all bi-direction, |
| | | 3: random */ |
| //// H.264 Slice & Upper Level | | |
| // | | |
| EntropyMode | = 0; | /* Specify CABAC(1) or VLC(0), valid in |
| | | H.264 mode */ |
| ChromaQPOffset | = 1; | /* H264, from −12 to 12 */ |
| Constrained_intra_pred_flag | = 1; | /* H264: 0: use of inter MB residual; 1: no use |
| | | of inter MB residual */ |
| Direct_8x8_inference_flag | = 1; | /* H264: at direct mode, 1: 8x8 partition; 0: |
| | | 4x4 partition */ |
| WeightedPrediction | = 1; | /* P picture Weighted Prediction (0=off, 1=explicit |
| | | mode) , valid in WMV9 and H.264 mode */ |
| WeightedBiprediction | = 1; | /* B picture Weighted Prediciton (0=off, 1=explicit |
| | | mode, 2=implicit mode) , valid in H.264 |
| | | mode */ |
| DirectModeType | = 0; | /* 0: temporal direct mode, 1: spatial direct mode, |
| | | valid in H.264 mode */ |
| MBAffFlag | = 0, | /* H264, valid when CodingOption = 1 */ |
| NumOfReferenceFrames | = 10; | /* H264: Number of previous frames used for |
| | | motion search */ |
| LongTermRefPic | = 1; | /* H264, 0: no long term ref pic, 1: randomly |
| | | assign to long-term ref pic */ |
| MultiRefBackwardAllowed | = 1; | /* H.264, 0: one ref for backward, 1: |
| | | multiple allowed */ |
| ReorderRefLists | = 1; | /* H.264 only, 0: no reordering, 1: reordering ref |
| | | lists allowed */ |

//// In-Loop Filter Parameters, valid for H.264

| | | |
|---|---|---|
| // | | |
| InLoopfilter | = 0; | /* If do in-loop filter (0: Enable, 1: Disable for |
| | | entire pic, 2: Disable in slice boundary */ |
| LoopFilterPresentFlag | = 1; | /* Configure in-loop filter (0=parameter below |
| | | ignored, 1=parameters sent) */ |
| LoopFilterAlphaC0Offset | = −1; | /* Alpha & C0 offset div. 2, {−6, −5, ... 0, +1, |
| | | .. +6}*/ |
| LoopFilterBetaOffset | = 1; | /* Beta offset div. 2, {−6, −5, ... 0, +1, .. +6} */ |
| //// H.264 MB Level | | |
| // | | |
| SubMotionSplitMode | = 3; | /* H264, split further when it is 8x8 partition. |
| | | 0: 8x8; 1: 8x4; 2: 4x8; 3: 4x4; 4: random mix |
| | | (equal probability). */ |
| Raw_Mode | = 1; | /* H264: 0: no raw mode; 1: random; 2: pattern |
| | | */ |
| Raw_mode_frequency | = 32; | /* H264: raw mode generated at one of |
| | | Raw_mode_frequency used in random mode |
| | | */ |
| LumaPredType | = 2; | /* 0: 16x16 intra prediction, 1: 4x4 intra prediction, |
| | | 2: mixed */ |
| LumaPredModeMB | = 4; | /* Luma prediction mode for H264 16x16: |
| | | 0-V, 1-H, 2-DC, 3-plane, 4-mix */ |
| LumapredModeSubblk | = 9; | /* luma prediction mode for sub-block 0-15 |
| | | 0-V, 1-H, 2-DC, 3-diagonal down left, 4- |
| | | diagonal down right, |
| | | 5-vertical right, 6-horizontal down, |
| | | 7-vertical left, 8-horizontal up, 9-mixed |
| | | */ |
| ChromaPredMode | = 4; | /* Chroma prediction mode: 0-DC, 1-H, |
| | | 2-V, 3-plane, 4-mixed */ |

APPENDIX D
AN EXEMPLARY PARAMETER COMBINATION THAT IS PERMISSIBLE UNDER
MPEG4 ACCORDING TO ONE EMBODIMENT OF THE PRESENT INVENTION

//// Most Used Fields
//

| | | |
|---|---|---|
| RandomSeed | = 1152; | // random number seed |
| SourceWidth | = 90; | // Source width |
| SourceHeight | = 72; | // Source height |
| FramesToBeEncoded | = 24; | // total frames to be encoded |

//// Sequence Parameters
//

| | |
|---|---|
| CompressMode | = 4; |

// 0: MPEG1, 1: MPEG2, 3: h263, 4: MPEG4 ASP, 5: H.264, 6: Corona, 7: WM9

| | |
|---|---|
| Profile_level | = 0; |
| GOPSize | = 12; |

// total frames in one GOP, 0 means only first frame is I frame

| | |
|---|---|
| NumOfBFrames | = 2; |

// Number of B frames inserted between two P/I frames

| | |
|---|---|
| QuarterPel | = 1; |

// MPEG4: 1: quarter pixel MV search, 0: half pixel MV search

| | |
|---|---|
| SliceMode | = 0; |

// 0: No slice; 1: fix slice pattern; 2: random slice pattern
//// Interlace
//
CodingOption = 3;
// Frame-level control: 0: frame coding, 1: adaptive frame/field coding,
// 2: field coding, 3: MB adaptive frame/field coding.
// MPEG4: only 0 and 3 can be enabled
// MPEG1/H263: only 0 can be enabled (no interlace coding)
// MPEG2/WM9/H264: all four options can be enabled
TopFieldFirst = 1;
// 0: bottom field first, 1: top field first
Alternate_vertical_scan = 2;
// MPEG4 only:0: Use default zigzag scan, 1: use alternate vertical zigzag scan in case of
// interlace, 2: random
//// Quantizer
//

| | |
|---|---|
| QuantizerForIFrames | = −1; // quantization for all I frames |
| QuantizerForPFrames | = −1; // quantization for all P frames |
| QuantizerForBFrames | = −1; // quantization for all B frames |
| QMode | = 1; // 0: always constant; 1: random; 2: pattern file |
| QuantType | = 1; |

// For MPEG4, 0: H.263, 1: MPEG-2; For MPEG2, 0: linear quant step, 1: non-linear
// quant step
//// Prediction Parameters

| | |
|---|---|
| MVMode | = 1; |

// 0: constant (0,1/4,1/2,3/4-pel), set by MV.x & MV.y;
// 1: random (determined by mean and variance range,
// generated value can't exceed Motion_vector_range)
// 2: comprehensive coverage: H-pel: 4 cases; Q-pel: 16 cases
Motion_vector_mean_range= 32;
// motion vector mean range in whole-pel unit, used when MVMode==1
Motion_vector_variance_range= 16;
// motion vector variance range in whole-pel unit, used when MVMode==1
Motion_vector_range= 32;
// motion vector search range: 16/32/64/128/256/512/1024, in whole-pel unit, used
// when MVMode==1
//// Macroblock Properties
//
Motion_type = 2;
// 0: all frame, 1: all field, 2: mix of frame & field (equal probability), 3: mix of frame &
// field (pattern file)
// field prediction can be enabled when CodingOption is set to 1, 2, or 3.
// frame prediction can be enabled when CodingOption is set to 0, 1, or 3.
DCT_type = 2;
// 0: all frame, 1: all field, 2: mix of frame & field (equal probability), 3: mix of frame &
// field (pattern file)
// field DCT can be enabled when CodingOption is set to 1, 2, or 3.
// frame DCT can be enabled when CodingOption is set to 0, 1, or 3.
MB_type = 2;
// 0: all intra, 1: all inter, 2: inter/intra mix
Intra_mode_frequency= 4;
// intra mode generated at one of Intra_mode_frequency used in inter/intra mix case
SplitMode = 4;
// 0: 16x16; 1: 8x8; 2: 16x8; 3: 8x16; 4: random mix (equal probability).
// Note: for MPEG4 16x16 and 8x8 split can be choose, and for field-prediction
// choosing 16x16 will be treated as 16x8 split.

| | |
|---|---|
| Skip_Mode | = 1; // 0: no skip mode; 1: random; 2: pattern |
| Direct_Mode | = 1; // 0: no direct mode; 1: random; 2: pattern |
| Skip_mode_frequency | = 16; |

// skip mode generated at one of Skip_mode_frequency (>1) used in random mode.
Direct_mode_frequency = 4;
// direct mode generated at one of Direct_mode_frequency used in random mode
//// MPEG4 Slice & Upper Level
//
DivXCompatible = 0;
// MPEG4 only: 1: the stream is DivX compatible, 0: it is not.
Intra_dc_vlc_thr = 8;
// MPEG4 only: 0: use intra DC VLC for entire VOP;
// MPEG4 only: 1: switch to intra AC VLC at running Qp>= 13
// MPEG4 only: 2: switch to intra AC VLC at running Qp>= 15
// MPEG4 only: 3: switch to intra AC VLC at running Qp>= 17
// MPEG4 only: 4: switch to intra AC VLC at running Qp>= 19
// MPEG4 only: 5: switch to intra AC VLC at running Qp>= 21
// MPEG4 only: 6: switch to intra AC VLC at running Qp>= 23
// MPEG4 only: 7: use intra AC VLC for entire VOP;
// MPEG4 only: 8: random use the above 8 cases per frame

| | |
|---|---|
| ACPred | = 1; |

// MPEG4 only: 1: enable AC coeffs prediction, 0: disable AC prediction
//// MPEG4 MB Level
//

| | |
|---|---|
| ACPred_frequency | = 2; |

// MPEG4 only: AC pred generated at one of ACPred_frequency (>0) when ACPred=1

| | |
|---|---|
| StuffingMBMode | = 0; |

// 0: Do not insert stuffing MB, 1: random insert stuffing MB
StressTest = 1;

What is claimed is:

1. A method of automatically generating a test vector for verification of a video encoder or decoder, comprising:
receiving video data for generating the test vector;
selecting a plurality of parameters for encoding the video data;
determining whether a combination of the selected plurality of parameters is permissible; and
generating the test vector by encoding the video data using the selected plurality of parameters in response to a determination that the combination is permissible.

2. The method of claim 1, further comprising discarding the selected plurality of parameters in response to a determination that the combination is impermissible.

3. The method of claim 1, wherein selecting the plurality of parameters comprises at least one of:
selecting a stream level parameter;
selecting a picture level parameter;
selecting a slice level parameter;
selecting a macroblock level parameter;
selecting a block level parameter; and
selecting a sub-block level parameter.

4. The method of claim 1, further comprising selecting a second plurality of parameters for encoding the video data.

5. The method of claim 1, wherein selecting the plurality of parameters comprises randomly selecting a parameter.

6. The method of claim 1, wherein selecting the plurality of parameters comprises selecting one or more parameters specified by a user.

7. The method of claim 1, wherein selecting the plurality of parameters comprises selecting one or more parameters to test a corner case.

8. The method of claim 1, wherein determining whether the combination of the selected plurality of parameters is permissible comprises at least one of:
determining whether the parameters in the combination are consistent; and
determining whether a parameter in the combination is permissible under a standard; and
determining whether the combination is permissible under a standard.

9. The method of claim 1, wherein the parameters are defined by one of the following standards: MPEG 1, MPEG 2, MPEG 4, H.263, H.264, and MSVC.

10. The method of claim 1, further comprising:
decoding the test vector by a video decoder to generate a decoded test vector; and
performing verification of the video decoder by comparing the decoded test vector with an expected value.

11. The method of claim 10, wherein decoding the test vector comprises at least one of:
variable length decoding;
inverse quantization;
inverse discrete cosine transform; and
inverse motion estimation and compensation.

12. The method of claim 1, wherein generating the test vector by encoding the video data using the selected plurality of parameters comprises:
encoding the video data by a video encoder to generate an encoded test vector; and
performing verification of the video encoder by comparing the encoded test vector with an expected value.

13. The method of claim 12, wherein encoding the video data comprises at least one of:
motion estimation and compensation;
a discrete cosine transform;
quantization; and
variable length coding.

14. The method of claim 1, further comprising:
changing a parameter of the plurality of parameters to generate a second plurality of parameters for encoding the video data;
determining whether a combination of the second plurality of parameters is permissible; and
generating a second test vector by encoding the video data using the second plurality of parameters in response to a determination that the combination of the second plurality of parameters is permissible.

15. A system for generating a test vector for verification of a video encoder or decoder, the system comprising:
a parameter generator having an input and an output for selecting a plurality of parameters for generating the test vector, the input of the parameter generator coupled to receive one or more parameters in the plurality;
a parameter filter having an input and an output for determining whether a combination of the selected plurality of parameters is permissible, the input of the parameter filter coupled to the output of the parameter generator to receive the selected plurality of parameters; and
a video encoder having a first input, a second input, and an output for generating the test vector, the first input of the video encoder coupled to the output of the parameter filter, the second input of the video encoder coupled to receive video data for generating the test vector.

16. The system of claim 15, further comprising a parameter multiplexer coupled to the input of the parameter generator for providing the one or more parameters in the plurality.

17. The system of claim 15, further comprising a standard library for storing the one or more parameters in the plurality, wherein the standard library stores at least one of the following types of parameters:
stream level parameters;
picture level parameters;
slice level parameters;
macroblock level parameters;
block level parameters; and
sub-block level parameters.

18. The system of claim 15, wherein the test vector comprises a bitstream encoded by performing at least one of the following encoding operations:
motion estimation and compensation;
a discrete cosine transform;
quantization; and
variable length coding.

19. The system of claim 15, further comprising a comparator having a first input and a second input for performing verification of the video encoder by comparing the test vector to an expected value, the first input of the comparator coupled to the output of the video encoder to receive the test vector, and the second input of the comparator coupled to receive the expected value.

20. The system of claim 15, wherein the parameter generator selects the plurality of parameters randomly.

21. The system of claim 15, wherein the parameter generator selects the plurality of parameters specified by a user.

22. The system of claim 15, wherein the parameter generator selects the plurality of parameters for testing a corner case.

23. The system of claim 15, wherein the parameter filter determines whether the combination of the selected plurality of parameters is permissible by at least one of:
determining whether the parameters in the combination are consistent;
determining whether a parameter in the combination is permissible under a standard; and
determining whether the combination is permissible under a standard.

24. The system of claim 15, wherein the parameters are defined by one of the following standards: MPEG 1, MPEG 2, MPEG 4, H.263, H.264, and MSVC.

25. The system of claim 15, further comprising a video decoder having an input and an output for decoding the test vector to generate a decoded test vector, the input of the video decoder coupled to receive the test vector from the video encoder.

26. The system of claim 25, wherein the video decoder performs at least one of the following operations:
variable length decoding;
inverse quantization;
inverse discrete cosine transform; and
inverse motion estimation and compensation.

27. The system of claim 25, further comprising a comparator having a first input, and a second input for performing verification of the video decoder by comparing the decoded test vector to an expected value, the first input of the comparator coupled to the output of the video decoder to receive the decoded test vector, and the second input of the comparator coupled to receive the expected value.
